(19) United States
(12) Patent Application Publication
(10) Pub. No.: US 2003/0051359 A1
(43) Pub. Date: Mar. 20, 2003

(54) Layout square

(76) Inventor: Paul Connor, Vidor, TX (US)

Correspondence Address: JAMES L. JACKSON, ANDREWS & KURTH, 600 TRAVIS, SUITE 4200, Houston, TX, 77002, US

(21) Appl. No.: 10/119,169

(22) Filed: Apr. 9, 2002

Related U.S. Application Data
(60) Provisional application No. 60/283,824, filed on Apr. 13, 2001.

(51) Int. Cl. B43L 7/027

(52) U.S. Cl. 33/474

(57) ABSTRACT

A framing layout square device for use by carpenters involved in locating spaced structural members for the framework of a building structure. The device has an elongate substantially straight positioning and measuring member having at least one straight edge for positioning contact with a structural member of a building framework. A plurality of transverse layout members project from one side said elongate positioning and measuring member beyond the straight edge and are located in spaced relation with one another. Each of the transverse layout members have at least one straight layout edge oriented in 90° relation with the straight edge of the positioning and measuring member, with the straight layout edges of the transverse layout members being parallel for defining equally spaced marking edges for marking the spaced locations of the structural members of a building framework. The transverse layout members may be fixed to the positioning and measuring member or may be movable to a storage position.

### CROSS-REFERENCE TO RELATED APPLICATION

Applicant hereby claims the priority in and the benefit of U.S. Provisional Application No. 60/283,824, filed by Paul Connor on Apr. 13, 2001 and entitled “Layout Square”, which Provisional Application is incorporated herein by reference for all purposes.

### BACKGROUND OF THE INVENTION

1. Field of the Invention

This invention generally concerns apparatus for use by carpenters and other such workers in the building industry and particularly by carpenters during the framing of a building structure. More particularly, the present invention concerns a layout square device which enables carpenters engaged in framing building structures to quickly, accurately and efficiently identify and mark the locations of framing components such as studs, rafters and joists, without the typical necessity for using tape measures and other measuring devices for location and marking of such framing components.

2. Description of the Prior Art

When building structures are framed, workers of a framing crew typically use measuring devices, such as a tape measure to identify the locations of framing members such as wall studs, floor and ceiling joists, roof rafters and the line. Typically, a worker will mark a small “V” on a sill or other structural member to identify the intended center of other structural members to be attached. The carpenter will then use a conventional square tool and mark a line that is squared to the sill. At times the carpenter will also measure and mark a line that is intended to be a guideline for location of the outer surface to a structural member. Later, the carpenter will align a wall stud or other structural member to the line scribed on the sill and will secure the wall stud in place, using nails or other suitable fasteners. Thus, the carpenter must individually measure and mark location lines for each structural member. This is a time consuming task which adds to the cost of the building structure. It is desirable therefore to provide means for efficiently locating framing members of a building structure without the necessity for time-consuming measuring, squaring and marking.

### SUMMARY OF THE INVENTION

It is a principal feature of the present invention to provide a novel framing layout square device for use by carpenters to enable efficient and accurate spacing layout of framing structural members, such as the vertical studs and horizontal floor and ceiling joists of a building framework, without necessitating the time consuming and labor intensive use of tape measures and other measuring devices.

It is also a feature of the present invention to provide a novel framing layout square device that enables carpenters to quickly and efficiently make evenly spaced and squared positioning marks on certain rectangular structural members of a building framework to thus efficiently facilitate accurate positioning of other framework members in functional relation therewith, and without necessitating the use of tape measures and carpentry squares to accomplish such accurate framework member positioning.

Briefly, the various objects and features of the present invention are realized by framing layout square device for use by carpenters involved in locating spaced structural members for the framework of a building structure. The layout square device has an elongate substantially straight positioning and measuring member having at least one straight positioning edge for positioning contact with a rectangular structural member, such as a 2″×4″ joist of a building framework. A plurality of transverse layout members project from one side said elongate positioning and measuring member beyond the straight positioning edge and are located in spaced relation with one another, with their spacing defining the intended spacing of building framework members, such as wall studs and floor and ceiling joists. Each of the transverse layout members have at least one straight layout edge oriented in 90° relation with the straight positioning edge of the positioning and measuring member, with the straight layout edges of the transverse layout members being parallel for defining equally spaced marking edges for marking the spaced locations of the structural members of a building framework. The transverse layout members may be fixed to the positioning and measuring member, such as by screws, rivets or by welding or may be movable to a storage position. If moveable, the transverse layout members may be removable from connection receptacles of the elongate positioning and measuring member or the transverse layout members may be pivotally connected with the elongate positioning and measuring member. If pivotally mounted for pivotal movement from a “use” position to a “storage” position, a positioning lock mechanism may be provided to lock the transverse layout members in precisely 90° orientation with respect to the straight positioning edge of the elongate positioning and measuring member. The locking mechanism may also retain the transverse layout members in the folded or storage positions thereof.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the preferred embodiment thereof which is illustrated in the appended drawings, which drawings are incorporated as a part hereof.

It is to be noted however, that the appended drawings illustrate only a typical embodiment of this invention and are therefore not to be considered limiting of its scope, for the invention may admit to other equally effective embodiments.

### IN THE DRAWINGS

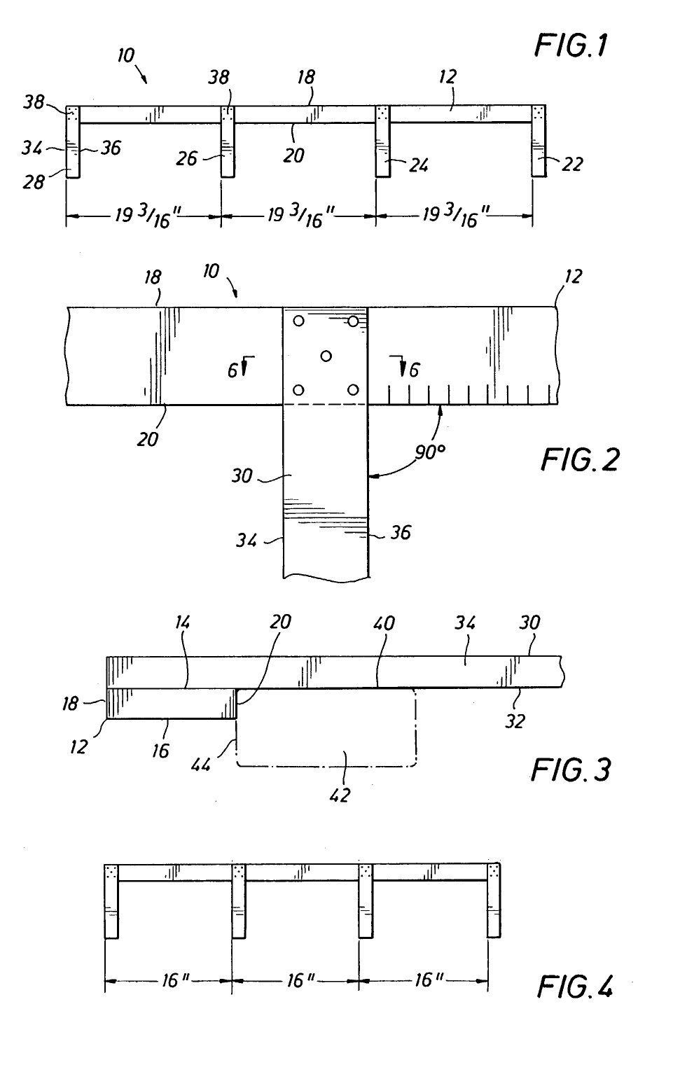

FIG. 1 is a plan view of a framing layout square device constructed according to the principles of the present invention and being designed for layout of framing members of a building structure with face-to-face spacing of the framing members on 19 3/16 inch centers;

FIG. 2 is a fragmentary plan view of the framing layout square of FIG. 1, showing indicia for measuring and showing connection of transverse stud, joist or rafter locating and squaring members to a primary orienting beam member thereof;

FIG. 3 is a partial end view showing the framing layout square of FIGS. 1 and 2 in measuring and squaring relation with a sill or cap member of a building structure;

FIG. 4 is a plan view of a framing layout square device constructed according to the principles of the present invention and being designed for layout of framing members of a building structure with 16 inch face-to-face spacing of the framing members;

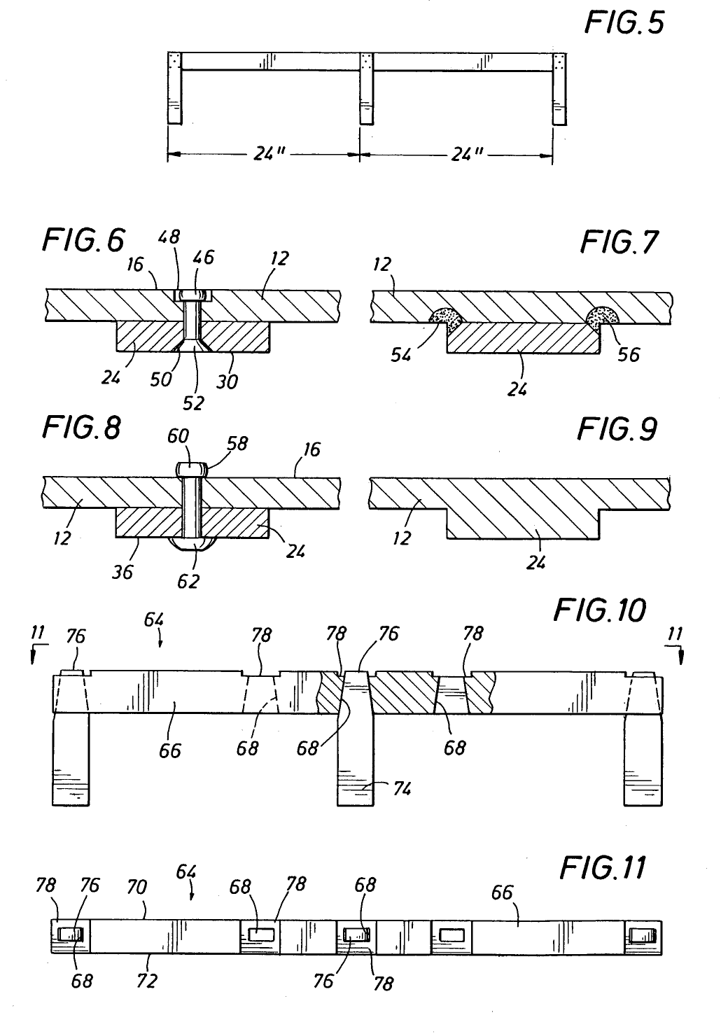

FIG. 5 is a plan view of a framing layout square device constructed according to the principles of the present invention and being designed for layout of framing members of a building structure with 24 inch face-to-face spacing of the framing members;

FIG. 6 is a fragmentary sectional view of a framing layout square device constructed according to the principles of the present invention, showing fixed connection of the elongate positioning and measuring member and transverse layout members thereof by countersunk rivet connection;

FIG. 7 is a fragmentary sectional view of a framing layout square device constructed according to the principles of the present invention, showing fixed connection of the elongate positioning and measuring member and transverse layout members thereof by welded connection;

FIG. 8 is a fragmentary sectional view of a framing layout square device constructed according to the principles of the present invention, showing fixed connection of the elongate positioning and measuring member and transverse layout members thereof by means of pop rivets;

FIG. 9 is a fragmentary sectional view of an alternative embodiment of the framing layout square device of the present invention, showing an elongate positioning and measuring member and transverse layout members that are integrally formed, such as by forging or molding of various metal or non-metal, i.e., polymer materials;

FIG. 10 is a plan view of an alternative embodiment of the present invention, with parts thereof broken away and shown in section and further illustrating removable transverse layout and squaring members to facilitate efficient storage when not in use and showing selective positioning of the removable transverse layout and squaring members to facilitate adaptation of the tool for differing stud spacing;

FIG. 11 is an elevational view taken along line 11-11 of FIG. 10 and illustrating the location of receptacles for receiving the removable removable transverse layout and squaring members;

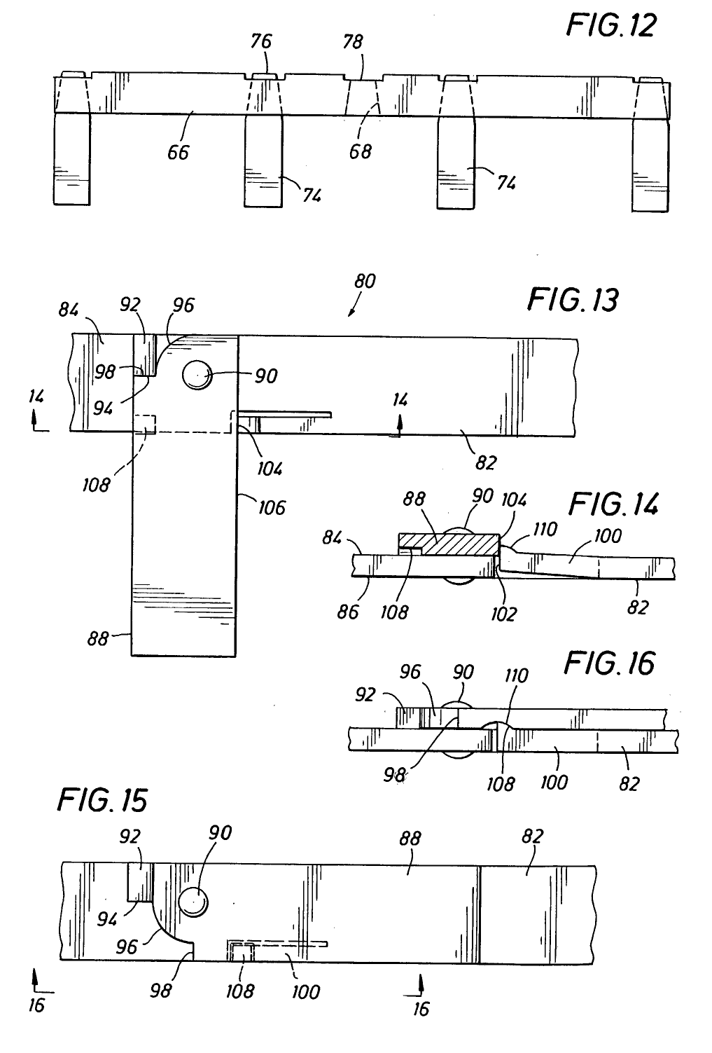

FIG. 12 is a plan view of a further alternative embodiment of the present invention illustrating removable transverse layout and squaring members to facilitate efficient storage when not in use and showing selective positioning of the removable transverse layout and squaring members to facilitate adaptation of the tool for differing stud spacing;

FIG. 13 is a partial plan view of another alternative embodiment of the present invention incorporating a plurality of transverse layout and squaring members that are pivotally mounted to an elongate positioning and measuring member, permitting the transverse layout and squaring members to be pivoted between a use position and a storage position and incorporating a locking mechanism for locking the transverse layout and squaring members at the use positions thereof;

FIG. 14 is a partial elevational and sectional view taken along line 14-14 of FIG. 13, illustrating the pivot and locking mechanism thereof in greater detail;

FIG. 15 is a partial plan view of the embodiment of FIGS. 13 and 14, showing a transverse layout and squaring member pivoted to the storage position thereof; and

FIG. 16 is an elevational view taken along line 16-16 of FIG. 15 and further showing details of the pivot and locking mechanism, with the elongate layout and squaring member in the storage position of FIG. 15.

### DETAILED DESCRIPTION OF PREFERRED EMBODIMENT

Referring now to the drawings and first to FIGS. 1-3, a framing layout square device constructed according to the principles of the present invention is shown generally at 10 and includes an elongate positioning and measuring member 12 which may be provided with indicia for use in measuring. Since the framing layout square device is intended to be rapidly and efficiently utilized as a layout tool, it may be provided without measuring indicia because measuring will be automatically done as the framing layout square device is used. The elongate positioning and measuring member 12 is preferably of generally rectangular cross-section, being defined by a length of metal strip material having substantially parallel top and bottom surfaces 14 and 16 respectively and parallel edge surfaces 18 and 20 as shown in FIGS. 2 and 3. Virtually any type of metal strip material may be utilized, such as aluminum, steel. Other non-metal materials such as suitable plastic materials may also be used. Preferably, because of its light weight and resistance to rusting, aluminum strip material is considered preferable for construction of the elongate positioning and measuring member 12 The length of the elongate positioning and measuring member 12 is determined by the desired number of transverse layout members that are intended. As shown in FIG. 1, the framing layout square device 10 includes four transverse layout members 22, 24, 26 and 28, with transverse layout members 22 and 28 being fixed to respective ends of the elongate positioning and measuring member 12 and transverse layout members 24 and 26 having ends thereof fixed to intermediate portions of elongate positioning and measuring member 12. The transverse layout members are arranged such that their respective side edges are equally spaced as shown.

The transverse layout members are preferably constructed of the same or similar strip material as the elongate positioning and measuring member 12. It has been determined that aluminum alloy strip material having a width of 2″ and a thickness of ¼″ can be efficiently used to define the elongate positioning and measuring member 12. Aluminum alloy strip material having a width of 1½″ and a thickness of ¼″ has been determined suitable for construction of the transverse lay out and squaring members 22-28. The transverse layout members are preferably of generally rectangular cross-sectional configuration, defining top and bottom, generally parallel surfaces 30 and 32 respectively and defining parallel side edges 34 and 36 as shown in FIGS. 2 and 3.

The transverse layout members are arranged at precise right angles to the elongate positioning and measuring member 12 so that one of the side edges thereof can be used as a guide for marking the position of a wall stud, floor or ceiling joist, roof rafter or the like. The transverse layout members are secured to the elongate positioning and measuring member 12 by rivets 38, preferably flush rivets, screws, by welding or by any other suitable means securing the transverse layout members in immovable and precisely oriented relation at 90° with respect to the elongate positioning and measuring member 12. This 90° angle provides the tool with a squaring capability, so that marks on the lumber or other building material will be squared with respect to the building material. Studs, joists, rafters and the like which are positioned with their side surfaces in alignment with these precisely oriented marks, will be located in squared relation as desired. The transverse layout members may be integrally formed with the elongate positioning and measuring member 12 if desired.

It should be noted that ends of the transverse layout members 22-28 are arranged in overlapped relation with the elongate positioning and measuring member 12, as is evident from FIGS. 2 and 3. Because of this overlapped relation, with the bottom surfaces of the transverse layout members lying in face-to-face relation with the upper surface 40 of the sill or other lumber member 42, the side edge 20 of the elongate positioning and measuring member 12 is used as a locating or positioning edge. The side edge 20 is positioned in engagement with a side surface 44 of the sill 42, thus orienting the side edges of all of the transverse layout member in 90°, i.e., squared relation with the side surface 44 of the sill. With the layout square device properly positioned with respect to a corner of the building structure or the end of a sill or other structural member of the building structure, squared layout lines are scribed on the sill by running a marking or scribing device along one or both edges of the transverse layout members as a guide. Wall studs, floor and ceiling joists, rafters and the line positioned with one of the side edges thereof in registry with the scribed marks, will be properly spaced and will be precisely squared so as to produce a quality framing structure, without the time, labor and expense of individually measuring and laying out the various spaced positioning lines that are needed for quality construction. Thus, without specifically taking measurements, the layout square tool of the present invention permit precise spacing and orientation of wall studs, floor joists and ceiling joists and permits panels of wallboard, plywood and the line to be properly positioned in relation to frame members of the building structure, so that efficient and secure fastening thereof to the framework for defining walls, ceilings and the like. The framing layout square device thus minimizes the time and cost that is involved in framing a building structure and permits quality buildings to be constructed at minimum cost.

FIG. 4 Illustrates a framing layout square device constructed according to the principles of the present invention and being arranged for location and squaring of framing members at 16″ centers. Otherwise, the construction and use of the framing layout square of FIG. 4 is essentially identical with respect to the framing layout square device shown in FIG. 1.

FIG. 5 Illustrates a framing layout square device constructed according to the principles of the present invention and being arranged for location and squaring of framing members at 24″ centers. Otherwise, the construction and use of the framing layout square of FIG. 5 is essentially identical with respect to the framing layout square device shown in FIG. 1.

As is evident from FIGS. 6-9, the transverse layout members may be secured to the elongate positioning and measuring member in any of a number of desirable ways. For example, as shown in FIG. 6, the elongate positioning and measuring member 12 and the transverse layout member 24 are secured in fixed assembly by a plurality of rivets 46. To ensure that the rivets do not project beyond the planar surfaces 16 and 30, countersinks 48 and 50 are defined, respectively, in the elongate positioning and measuring member 12 and the transverse layout member 24. The countersink 50 is of tapered configuration to receive the tapered head 52 of the rivet. The countersink 48 is straight walled, with a flat bottom surface to permit a rivet deforming tool to enter the countersink and deform the end of the rivet and thus secure the elongate positioning and measuring member 12 and the transverse layout member 24 in fixed assembly. Typically, a number of rivets will be employed for securing each of the transverse layout members to the elongate positioning and measuring member, so that the resulting framing layout square will withstand significant impacts during use, without the transverse layout members becoming misaligned.

According to FIG. 7, the elongate positioning and measuring member 12 and the transverse layout member 24 are maintained in precisely aligned and fixed assembly by welding, as shown at 54 and 56. According to FIG. 8, the elongate positioning and measuring member 12 and the transverse layout member 24 are secured in fixed assembly by means of pop rivets 58 which extend through registering apertures. In this case, the rivet heads 60 and 62 will project beyond the planar surfaces 16 and 36 as shown, unless countersinks are provided as shown in FIG. 6. The rigid relationship of the elongate positioning and measuring member 12 and the transverse layout member 24 is accomplished when the framing layout and measuring square device is an integral molded unit as shown in FIG. 9, being molded of metal, such as aluminum alloy or any of a number of non-metal materials, such as a polymer. Also, if desired, the elongate positioning and measuring member 12 may be composed of a metal material such as steel, aluminum alloy, bronze, etc. and the transverse layout members may be molded units, being molded of aluminum alloy, a polymer or any of a number of other suitable materials.

It is deemed necessary that there be a rigid assembly of the transverse layout members to the elongate positioning and measuring member of the framing layout square device of the present invention or that the transverse layout members, if moveable relative to the elongate positioning and measuring member, be capable of stable, essentially immovable location in precisely 90° relation with the elongate positioning and measuring member. According to FIGS. 10 and 11, a framing layout square device representing an alternative embodiment of the present invention is shown generally at 64, having an elongate positioning and measuring member 66 defining a plurality of tapered receptacles 68 that are disposed in spaced relation and are located substantially centrally between the upper and lower planar surfaces 70 and 72 of the elongate positioning and measuring member 66. A plurality of transverse layout members 74 are provided, each having a tapered end 76 being receivable in tight fitting relation with a tapered receptacle 68 and establishing a substantially immovable, precisely 90°oriented relation of the transverse layout members with the elongate positioning and measuring member 66. The receptacles 68 are spaced in a manner that a worker may selectively located the transverse layout members 74 for any of several typical stud spacings, thus adapting the tool for the stud spacing that is desired for the building structure. For example, the embodiment of FIG. 12 shows tapered receptacles that are arranged to permit the framing layout square device to be easily adapted for two differing stud spacing arrangements simply by strategically locating the transverse layout members 74 for desired stud spacing.

Since the tapered ends of the transverse layout members cannot be easily pulled from their receptacles, because of the wedged relationship that is established during assembly, the elongate positioning and measuring member 66 defines a recess 78 at each of the tapered receptacles 68, thus exposing a portion of the ends of the transverse layout members when the transverse layout members are fully seated as shown in FIG. 10. To then remove the transverse layout members from their tapered receptacles, such as for efficient storage or transportation of the framing layout square device, a worker can use a hammer, such as a soft faced mallet, to unseat the tapered ends of the transverse layout members from their tapered receptacles.

With reference now to FIGS. 13-16, it should be borne in mind that the transverse layout members may be pivotally connected with the elongate positioning and measuring member to thus permit the transverse layout members to be pivotally moveable from a “use” position, where the transverse layout members are disposed in 90°, substantially immovable relation with the elongate positioning and measuring member as shown in FIGS. 13 and 14, and a “storage” position, where the transverse layout members are disposed in overlying relations along portions of the length of the elongate positioning and measuring member as shown in FIGS. 15 and 16. According to the embodiment of FIGS. 13-16 a “folding” framing layout square device is shown generally at 80 and incorporates an elongate positioning and measuring member 82 having upper and lower generally planar surfaces 84 and 86 that are disposed in substantially parallel relation. The elongate positioning and measuring member 82 can be composed of metal strip material such as steel, aluminum alloy, bronze or the like, or may be composed of any of a number of suitable polymer materials. A plurality of transverse layout members 88 are each connected in pivotal relation with the elongate positioning and measuring member 82 by means of pivot elements 90 which may be defined by a rivet member extending through registering apertures in the elongate positioning and measuring member 82 and the transverse layout members 88. The pivot elements thus secure the transverse layout members 88 in pivotal relation with the elongate positioning and measuring member 82 and permit their pivotal movement from a “use” position, where the transverse layout members are disposed in 90°, substantially immovable relation with the elongate positioning and measuring member as shown in FIGS. 13 and 14, and a “storage” position, where the transverse layout members are disposed in overlying relations along portions of the length of the elongate positioning and measuring member as shown in FIGS. 15 and 16. As mentioned above, it is necessary that, in the use position of FIGS. 13 and 14, the transverse layout members be substantially immovable with respect to the elongate positioning and measuring member and that the transverse layout members are capable of remaining precisely oriented at 90° relation with respect to the elongate positioning and measuring member, for accurate stud location even when the tool is subjected to substantial jarring or impacting other objects during its use on a job site. To accomplish this feature, a positioning block 92 is fixed to the upper surface 84 of the elongate positioning and measuring member 82 and defines a stop shoulder 94. A portion of the transverse layout member 88 is cut away to defined an arcuate guide surface 96 and to define a positioning shoulder 98 that is disposed for movement limiting contact with the stop shoulder 94 when the transverse layout member 88 has attained precisely 90° positioning with respect to the elongate positioning and measuring member 82. To lock or retain the transverse layout member 88 at its use position, as shown in FIG. 13, a spring-like lock finger 100 is integral with the elongate positioning and measuring member 82 and defines a locking shoulder 102 that, in the locking condition of the device or tool, engages a shoulder 104 which is defined by a portion of a side edge 106. To release this locking relationship, the user of the device will simply apply manual force to the lock finger, flexing it downwardly from the FIG. 14 position sufficiently to move the locking shoulder 102 clear of the shoulder 104. When so unlocked, the transverse layout member 88 can be rotated about its pivot 90 until it is aligned with the elongate positioning and measuring member 82 as shown in FIGS. 15 and 16. To maintain the transverse layout member 88 in its folded or storage position with respect to the elongate positioning and measuring member 82, a retainer recess 108 is defined in the transverse layout member as shown, which receives an annular surface projection 110 of the locking finger 100 as is evident from FIG. 16. The a retainer recess 108 is defined in the transverse layout member as shown, which receives an annular surface projection 110 provides sufficient retention capability to secure the transverse layout member 88 in its folded or storage position. When use of the tool is needed, the user will simply apply sufficient manual rotational force to the transverse layout member 88 to pivot it from its folded or storage position to its use position, with locking by the spring-like locking finger 100 occurring when the transverse layout member 88 has reached its use position of FIG. 13. This feature permits the tool to be folded to a narrow elongate configuration for storage or transportation and to be manually conditioned simply and efficiently for use.

In view of the foregoing it is evident that the present invention is one well adapted to attain all of the objects and features hereinabove set forth, together with other objects and features which are inherent in the apparatus disclosed herein.

As will be readily apparent to those skilled in the art, the present invention may easily be produced in other specific forms without departing from its spirit or essential characteristics. The present embodiment is, therefore, to be considered as merely illustrative and not restrictive, the scope of the invention being indicated by the claims rather than the foregoing description, and all changes which come within the meaning and range of equivalence of the claims are therefore intended to be embraced therein.

I claim:

1. A framing layout square device for use by carpenters involved in locating spaced structural members for the framework of a building structure, comprising:
an elongate substantially straight positioning and measuring member having at least one straight edge for positioning contact with a structural member of a building framework; and
a plurality of transverse layout members projecting from one side said elongate positioning and measuring member beyond said straight edge and being located in spaced relation with one another, each of said plurality of transverse layout members having at least one straight layout edge oriented in 90° relation with said at least one straight edge, said straight layout edges of said transverse layout members being disposed in parallel relation and defining equally spaced marking edges for marking the spaced locations of the structural members of a building framework.

2. The framing layout square device of claim 1, comprising:
said elongate substantially straight positioning and measuring member having substantially planar top and bottom surfaces being disposed in substantially parallel relation; and
said plurality of transverse layout members each having substantially planar top and bottom surfaces, with portions of said planar bottom surfaces thereof being disposed in face-to-face relation with portions of said planar top surfaces of said elongate substantially straight positioning and measuring member.

3. The framing layout square device of claim 1, comprising:
said plurality of transverse layout members being located above said at least one straight edge, such that with said at least one straight edge in contact with a rectangular structural member of a building framework said plurality of transverse layout members lie in face-to-face relation on a planar surface of the rectangular structural member.

4. The framing layout square device of claim 1, comprising:
said plurality of transverse layout members being fixed to said elongate substantially straight positioning and measuring member with said at least one straight layout edge oriented in 90° relation with said at least one straight edge.

5. The framing layout square device of claim 4, comprising:
a plurality of rivets fixing said transverse layout members being fixed to said elongate substantially straight positioning and measuring member.

6. The framing layout square device of claim 5, comprising:
said transverse layout members and to said elongate substantially straight positioning and measuring member each defining a plurality of countersinks; and
said plurality of rivets each having heads located within said plurality of countersinks so the heads of said plurality of rivets do not project beyond said transverse layout members and said elongate substantially straight positioning and measuring member.

7. The framing layout square device of claim 4, comprising:
a plurality of pop-rivets fixing said transverse layout members being fixed to said elongate substantially straight positioning and measuring member.

8. The framing layout square device of claim 4, comprising:
weld connections fixing said transverse layout members to said elongate substantially straight positioning and measuring member.

9. The framing layout square device of claim 1, comprising:
pivots connecting each of said transverse layout members to said elongate substantially straight positioning and measuring member and permitting pivotal movement of said transverse layout members between a use positions oriented in substantially normal relation with said elongate substantially straight positioning and measuring member and storage positions oriented in substantial alignment with said elongate substantially straight positioning and measuring member.

10. The framing layout square device of claim 9, comprising:
first positioning elements being defined by said elongate substantially straight positioning and measuring member; and
second positioning elements being defined by each of said transverse layout members and being in contact with said first positioning element for locating said transverse layout members with said at least one straight layout edge oriented in 90° angular relation with said at least one straight edge.

11. The framing layout square device of claim 9, comprising:
a first locking mechanism releasably securing each of said transverse layout members in substantially immovable relation with said elongate substantially straight positioning and measuring member with said straight layout edges of said transverse layout members oriented in 90° angular relation with said straight edge of said elongate substantially straight positioning and measuring member.

12. The framing layout square device of claim 11, comprising:
a second locking mechanism releasably securing each of said transverse layout members in substantially aligned relation with said elongate substantially straight positioning and measuring member to permit ease and simplicity of storage and transportation of said framing layout square device when not in use.

13. A framing layout square device for use by carpenters involved in locating spaced structural members for the framework of a building structure, comprising:
an elongate substantially straight positioning and measuring member of predetermined length and having planar top and bottom surfaces and a straight positioning edge extending along the length thereof for positioning contact with a rectangular structural member of a building framework; and
a plurality of transverse layout members each having top and bottom surfaces and each being fixed to said elongate substantially straight positioning and measuring member with said bottom surfaces thereof, said plurality of transverse layout members projecting from one side said elongate positioning and measuring member beyond said straight edge, said plurality of transverse layout members being located in spaced relation with one another and each having at least one straight layout edge oriented in 90° relation with said at least one straight edge, said straight layout edges of said transverse layout members being disposed in parallel relation and defining equally spaced layout marking edges for marking the spaced locations of the rectangular structural members of a building framework.

14. The framing layout square device of claim 13, comprising:
said elongate positioning and measuring member and said transverse layout members each being defined by elongate strips of substantially flat material each defining substantially planar top and bottom surfaces;
one end portion of each of said transverse layout members being positioned in partially overlapping relation with said top surface of said elongate substantially straight positioning and measuring member with a portion of said bottom surface of said transverse layout members being in face-to-face contact with portions of said top surface of said elongate substantially straight positioning and measuring member; and
at least one connecting element extending through said overlapping portions of said elongate substantially straight positioning and measuring member and said transverse layout members and securing the same in fixed assembly.

15. The framing layout square device of claim 13, comprising:
said elongate substantially straight positioning and measuring member and said transverse layout members being integral.

16. The framing layout square device of claim 13, comprising:
said elongate substantially straight positioning and measuring member and said transverse layout members being interconnected by welding.

17. The framing layout square device of claim 13, comprising:
said elongate substantially straight positioning and measuring member and said transverse layout members being molded of a substantially rigid material.

18. The framing layout square device of claim 13, comprising:
said elongate substantially straight positioning and measuring member having substantially planar top and bottom surfaces being disposed in substantially parallel relation; and
said plurality of transverse layout members each having substantially planar top and bottom surfaces and being located above said at least one straight edge, with portions of said planar bottom surfaces thereof being disposed in face-to-face relation with portions of said planar top surfaces of said elongate substantially straight positioning and measuring member such that with said at least one straight edge in contact with a rectangular structural member of a building framework said plurality of transverse layout members lie in face-to-face relation on a planar surface of the rectangular structural member.

19. The framing layout square device of claim 13, comprising:
pivots connecting each of said transverse layout members to said elongate substantially straight positioning and measuring member and permitting pivotal movement of said transverse layout members between a use positions oriented in substantially normal relation with said elongate substantially straight positioning and measuring member and storage positions oriented in substantial alignment with said elongate substantially straight positioning and measuring member;
a first locking mechanism releasably securing each of said transverse layout members in substantially immovable relation with said elongate substantially straight positioning and measuring member with said straight layout edges of said transverse layout members oriented in 90° angular relation with said straight edge of said elongate substantially straight positioning and measuring member; and
a second locking mechanism releasably securing each of said transverse layout members in substantially aligned relation with said elongate substantially straight positioning and measuring member to permit ease and simplicity of storage and transportation of said framing layout square device when not in use.

20. A method for accomplishing spacing layout of the rectangular structural members of a building framework with a framing layout tool having an elongate positioning and measuring member defining a straight positioning edge and having a plurality of transverse layout members projecting laterally from one side of said elongate positioning and measuring member and beyond said straight positioning edge and each having top and bottom planar surfaces and each defining a straight layout marking edge oriented in 90° angular relation with said straight positioning edge and with said straight marking edges of said transverse layout members establishing layout spacing of the structural members of the building framework, said method comprising:
positioning said framing layout square device with said straight edge of said elongate positioning and measuring member in contact with a straight edge of a rectangular framework member and with said plurality of transverse layout members lying on and in face-to-face relation with a surface of the rectangular framework member and being oriented with said straight layout marking edges oriented in 90° angular relation the engaged straight edge of the rectangular framework member;
running a marking device along said straight layout marking edge of each of said transverse layout members for making corresponding straight equally spaced frame positioning marks on the rectangular framework member for subsequent accurate spaced location of other rectangular frame members relative thereto; and
Positioning and attaching building frame members with edges thereof in registry with the straight equally spaced positioning marks.
